(19) United States
(12) Patent Application Publication
(10) Pub. No.: US 2013/0038194 A1
(43) Pub. Date: Feb. 14, 2013

(54) Refrigeration shelving system

(71) Applicant: Glenn Erckert, Old Bridge, NJ (US)

(72) Inventor: Glenn Erckert, Old Bridge, NJ (US)

(21) Appl. No.: 13/136,809

(22) Filed: Aug. 11, 2011

(51) Int. Cl. F25D 25/02; B23P 11/00

(52) U.S. Cl. 312/408; 29/428

(57) ABSTRACT

A system and method of maximizing space inside a storage compartment of a refrigerator is provided. The storage compartment has a storage space defined by a rear wall, a side wall, and a standard refrigerator shelf. An auxiliary shelving system is provided, having a first support wall and a second support wall, and a plurality of auxiliary shelves. Each support wall has a plurality of spaced apart feet, the support walls being perpendicularly joined together to form an L-shaped configuration. The first support wall is positioned adjacent the rear wall and the second support wall is positioned adjacent the side wall, and with the feet resting on the standard refrigerator shelf. An edge of each auxiliary shelf is removably secured to a portion of either the first support wall or the second support wall so that the auxiliary shelf extends into the storage space of the storage compartment.

### RELATED APPLICATIONS

This application is related to Provisional Application No. 61/336,338, filed Jan. 21, 2010.

### BACKGROUND OF THE INVENTION

1. Field of the Invention

The present invention relates to refrigerator shelving, and in particular, to a portable shelving system that can be adapted for use in standard refrigerators.

2. Description of the Prior Art

Most household refrigerators are a bustling temporary storage hub for a large variety of items, all with vast differences in size, shape, and storage requirements, with items that are tall, short, bulky, flat, solid, liquid, and everything in between. With the exception of many small long-term items that pack the door shelves and assorted produce and such that occupy the drawers, the bulk of the storage burden lies within the humble means of the main compartment. Typically composed of three shelves, these limited areas are constantly challenged to accommodate items that, because of their vastly different dimensions and configuration, do not utilize the space well. And within this often delicate and chaotic balance, every new item can often create a dilemma, especially if that new item is not stackable but rather is something covered in plastic wrap, foil, etc. that cannot support weight.

One plate of unfinished or saved food can occupy an 11″ footprint of valuable shelf space (30-45%), leaving the vertical space above it wasted until necessity and frustration lead to placing items on top (resulting in compressed, unappetizing mush) or precariously balancing it on other items, creating an even greater challenge to access those other items. Delicate items such as cake, for example, complicate the issue even further. Even in the absence of these specialty items, the constant need to stack, jam, move, and restack items results in small items getting lost, large items being jammed in, delicate items being spilled, leaked or crushed, and in the end, much underutilized valuable space.

Thus, there remains a need to better utilize the valuable storage space within the main compartment of a conventional refrigerator.

### SUMMARY OF THE DISCLOSURE

It is an object of the present invention to provide a system that utilizes the storage space in the main compartment of a conventional refrigerator more effectively.

In order to accomplish the objects of the present invention, the present invention provides a system and method of maximizing space inside a storage compartment of a refrigerator, the storage compartment having a storage space defined by a rear wall, a side wall, and a standard refrigerator shelf. An auxiliary shelving system is provided, having a first support wall and a second support wall, and a plurality of auxiliary shelves. Each support wall has a plurality of spaced apart feet, the support walls being perpendicularly joined together to form an L-shaped configuration. The first support wall is positioned adjacent the rear wall and the second support wall is positioned adjacent the side wall, and with the feet resting on the standard refrigerator shelf. An edge of each auxiliary shelf is removably secured to a portion of either the first support wall or the second support wall so that the auxiliary shelf extends into the storage space of the storage compartment.

### BRIEF DESCRIPTION OF THE DRAWINGS

FIG. 1 is a perspective view of a refrigerator shelving system according to the present invention.

FIG. 2 is an enlarged front plan view of a portion of a refrigerator with the shelving system of FIG. 1 incorporated therein.

FIG. 3 illustrates a refrigerator that incorporates the shelving system of FIG. 1, showing the location of FIG. 2.

FIG. 4 is front view of a support wall of the shelving system of FIG. 1.

FIG. 5 is rear view of the support wall of FIG. 4.

FIG. 6 is a front view of an auxiliary shelf of the shelving system of FIG. 1.

FIG. 7 is a side view of the shelf of FIG. 6.

FIG. 8 is a top view of the shelf of FIG. 6.

FIG. 9 is an enlarged view illustrating how a pin connects an auxiliary shelf to a support wall.

FIG. 10 illustrates a connecting pin.

FIG. 11 is a bottom view illustrating one arrangement of auxiliary shelves.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a shelving system 20 that creates a versatile storage environment within the existing shelf compartments C of a conventional refrigerator that easily changes to accommodate all storage needs. Utilizing a system of smaller auxiliary shelves 32 with multiple configuration possibilities, the lateral and vertical shelf placement is totally adjustable and allows the choice of a wide variety of organization patterns.

The shelving system 20 of the present invention can be easily installed in any standard refrigerator, with no tools or hardware required. In addition, the system of the present invention requires minimal framework, so it occupies little existing space within the main compartment of the refrigerator. As a result, it is never in the way when not in use, but always ready and available when it is needed.

The shelving system of the present invention functions as a freestanding supplemental shelving unit for conventional refrigerators. By complementing existing refrigerator shelving, its versatile segmental design allows an individual to choose the amount of extra shelf space needed, from a larger shelf to safely stack a plate of food, to a small dedicated perch for small items. The lateral and vertical auxiliary shelf 32 placements are totally adjustable and the segmental design allows the choice of whatever organization pattern works for the individual and/or situation.

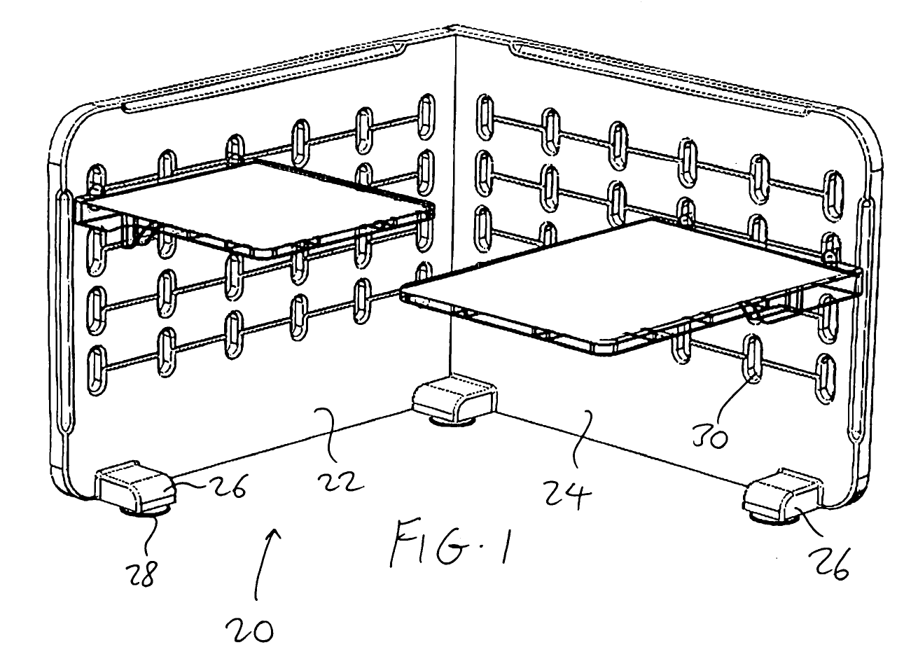

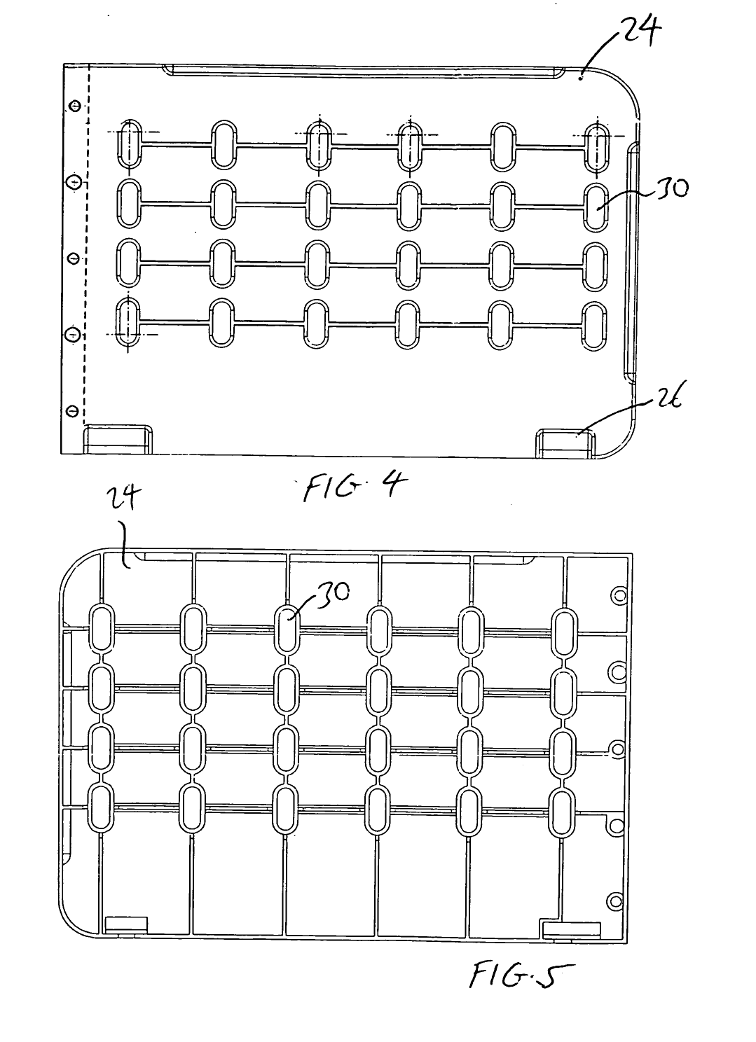

Referring now to FIGS. 1-5, the shelving system 20 of the present invention includes a first support wall 22 and a second support wall 24. The two support walls 22, 24 can be square or rectangular, and can be connected to each other (e.g., by a snap-fit connection) along a side of each support wall 22, 24 in a manner such that the support walls 22, 24 are perpendicular to each other to form an L-shaped support structure. This allows the first support wall 22 to be positioned adjacent the rear wall R of a refrigerator compartment C, and the second support wall 24 to be positioned adjacent the right wall of the refrigerator compartment C. Each support wall 22, 24 has one or more stabilizing feet 26 provided along the bottom thereof, with a suction cup 28 provided at the base of each foot 26. The feet 26 extend perpendicularly from the base of each support wall 22, 24 to provide stability, while the suction cups 28 function to secure the support wall 22, 24 to a refrigerator shelf S to prevent slipping or sliding of the support wall 22, 24. The feet 26 and the accompanying suction cups 28 are specifically designed to make the system 20 stable on a standard glass refrigerator shelf.

Each support wall 22, 24 also includes a plurality of support holes 30. These support holes 30 are arranged in a plurality of rows and columns to receive anchoring hooks 34 from the separate auxiliary shelves 32, so that the auxiliary shelves 32 can be positioned at a variety of different locations along either support wall 22, 24.

According to one embodiment, each support wall 22, 24 can be about 13 inches long, 9 inches high, and 0.5 inches thick, so as to fit easily into a conventional compartment C of a conventional refrigerator. Four rows of holes 30 can be provided, with six holes 30 in each row.

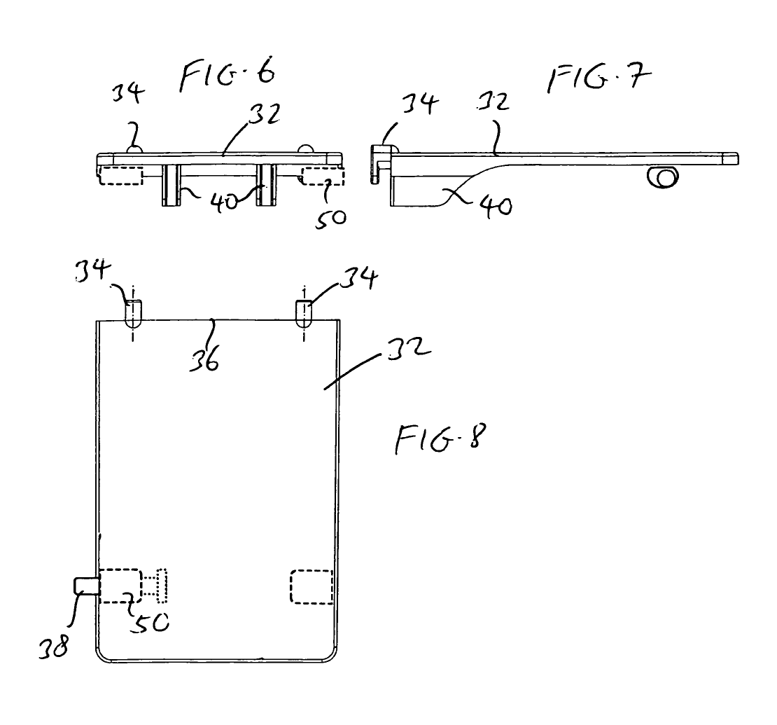

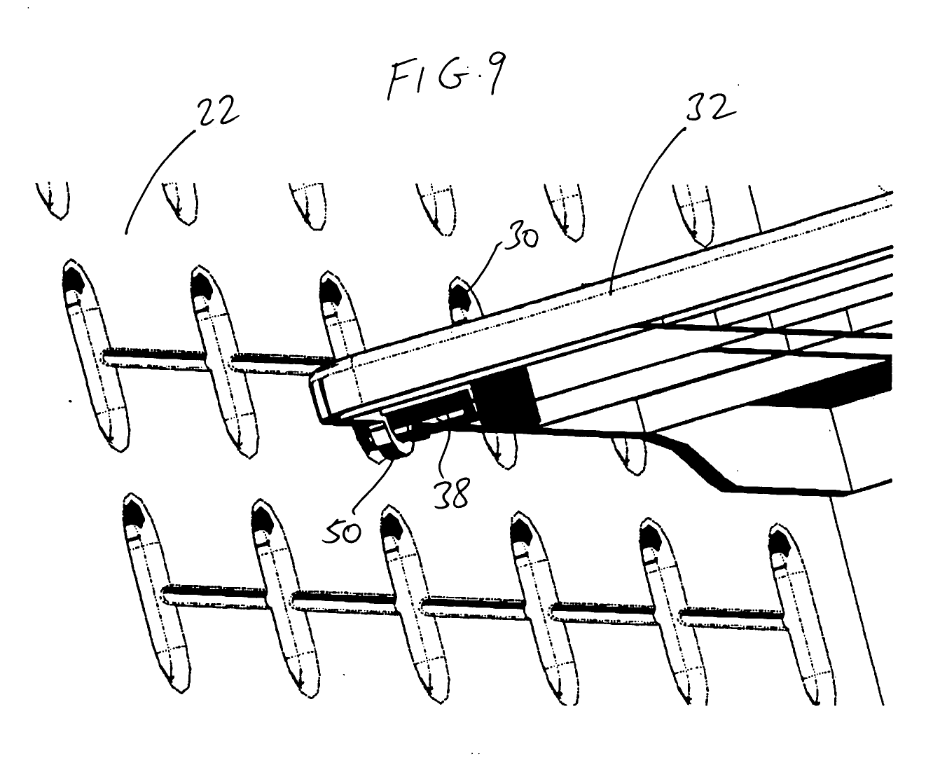

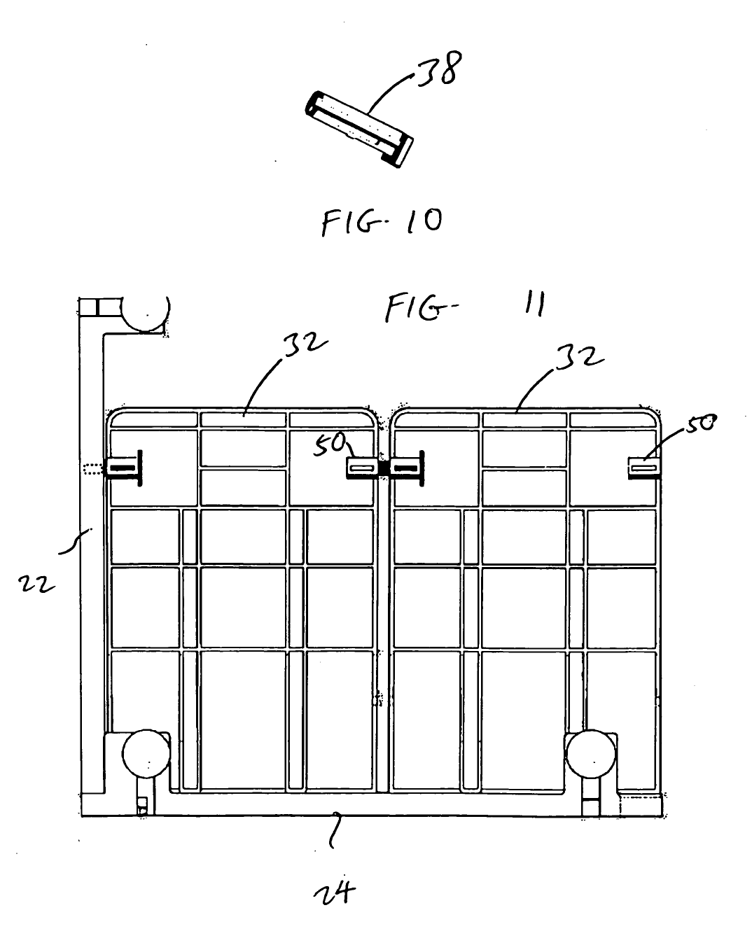

Referring also to FIGS. 6-10, each auxiliary shelf 32 can be rectangular or square in configuration, with a thickness of about 0.35 inches. Two hooks 34 extend from the rear edge 36 of the shelf 32, with each hook 34 adapted to insert through a hole 30 in a support wall 22, 24 to support the shelf 32. A pair of braces 40 are provided below the shelf 32 along the rear edge 36 to brace and further support the shelf 32 against the support wall 22, 24 in a manner which prevents the shelf 32 from flexing downwardly when an object is placed on the shelf 32. Therefore, with the two hooks 34 spaced apart along the rear edge 36, the shelf 32 can be connected to a support wall 22, 24 in a stable manner.

In addition, two sleeves 50 are provided on the underside of the front end of each shelf 32 and are adapted to receive a support pin 51. The support pin 38, when contained in a sleeve 38, can be advanced into a hole 30 when needed in a manner which prevents the shelf 32 from flexing downwardly when an object is placed on the shelf 32.

The size of the shelf 32 can be varied. For example, a larger shelf 32 can have a length of about 9 inches and a width of about 6 inches, while a smaller shelf 32 can have a length of about 6 inches and a width of about 5.5 inches. The shelves 32 can be provided in different shapes and sizes, for example, with two small and two slightly larger shelves 32. The smaller-sized shelves 32 allow for convenient storage of a singular or multiple small items (or stacking of the same by vertical alignment of the shelves 32), or they can be combined to create a larger shelf unit by aligning them horizontally along the same vertical plane for greater storage opportunities (as described below).

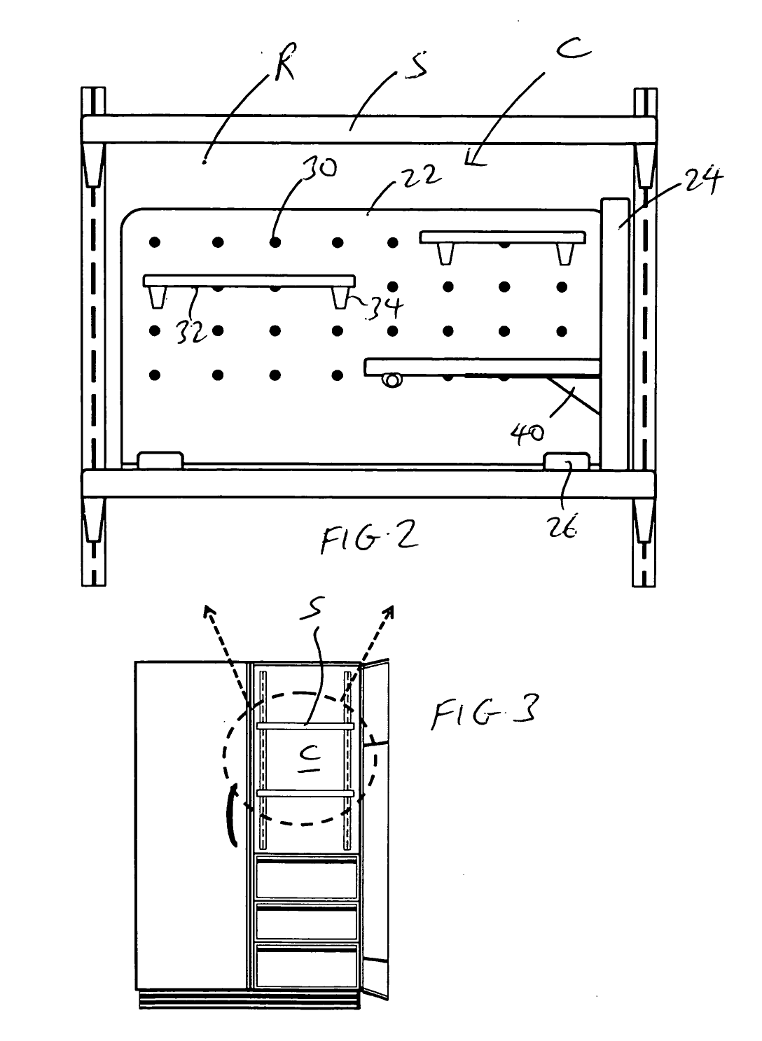

As shown in FIG. 2, auxiliary shelves 32 of different sizes can be secured to the first support wall 22 at different locations so as to maximize the number of plates and items that can be fitted into a conventional refrigerator compartment C. Depending on what needs to be stored, the user can adjust the locations of these shelves 32. FIGS. 11-12 illustrate a unique arrangement of two shelves 32 where the two shelves 32 are positioned side-by-side to provide a larger combined auxiliary shelf. To provide additional support and stability, a pin 38 can be extended through aligned sleeves 50 that are positioned along the edges of the two shelves 32 so that the two shelves 32 are now configured as a unitary shelf that is secured to portions of both support walls 22 and 24. In other words, a second shelf 32 containing the same sleeve 50 and support pin 38 assembly as the first shelf, and positioned parallel and adjacent to first shelf 32, can be similarly supported by the first shelf 32 by advancing the support pin 38 of the second shelf 32 into the free and open sleeve 50 of first shelf 32, in a manner which prevents the combined shelves 32 from flexing downwardly when an object is placed on the combined shelves 32.

The shelving system 20 can be deployed as follows. The user can place the support walls 22, 24 into a desired refrigerator compartment C, with the support wall 22 adjacent the rear of the compartment C and the support wall 24 adjacent a right wall of the compartment C. The feet 26 provide stability to the support walls 22, 24, and the suction cups 28 maintain the support walls 22, 24 at fixed locations on the refrigerator shelf defining the bottom of the selected compartment C. Then, depending on the items (e.g., dishes, containers, boxes, etc.) that the user wishes to place and arrange into the selected compartment C, the user can fix one or more shelves 32 to either or both support walls 22, 24 in an arrangement which maximizes the use of space within the selected compartment C. Each shelf 32 can be secured by inserting a hook 34 into selected holes 30 on the support wall(s) 22, 24. The pins 38 can be inserted through selected sleeves 50 and into selected holes in the support walls 22, 24 for additional support and stability. If a larger shelf size is needed, two or more shelves 32 can be combined by using pins 38 to connect adjacent edges of the shelves 32 (via the sleeves 50, as shown in FIGS. 11 and 12).

The materials used for the components of the system of the present invention can vary between any materials that will provide the necessary structural support and design details, and will most likely be governed by contributing factors such as cost, aesthetics, structural strength, overall performance, etc. Such materials include plastic, composite material, fiberglass, metal, etc.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. In combination:
a refrigerator having a storage compartment that has a storage space defined by a rear wall, a side wall, and a standard refrigerator shelf;
an auxiliary shelving system comprising:
a first support wall and a second support wall, each support wall having a plurality of spaced apart feet, the support walls being perpendicularly joined together to form an L-shaped configuration, with the first support wall positioned adjacent the rear wall and the second support wall positioned adjacent the side wall, and with the feet resting on the standard refrigerator shelf; and
a plurality of auxiliary shelves, each auxiliary shelf having one edge that is removably connected to a portion of either the first support wall or the second support wall so that the auxiliary shelf extends into the storage space of the storage compartment.

2. The combination of claim 1, wherein a plurality of holes are provided in the first and second support walls, and wherein each auxiliary shelf has a plurality of ears provided along at least one edge of the auxiliary shelf, further including a plurality of connection pins, with each pin extending through an ear into a corresponding hole in either of the support walls, so to connect an auxiliary shelf to a support wall.

3. The combination of claim 1, further including a suction cup provided at the bottom of each of the feet.

4. The combination of claim 1, wherein the plurality of auxiliary shelves includes shelves of different shapes and sizes.

5. The combination of claim 1, wherein each auxiliary shelf further includes at least one brace.

6. The combination of claim 1, wherein two auxiliary shelves are positioned side-by-side to each other, and a pin connects the ears on the adjacent edges of the two auxiliary shelves.

7. A method of maximizing space inside a storage compartment of a refrigerator, the storage compartment having a storage space defined by a rear wall, a side wall, and a standard refrigerator shelf, comprising the steps of:
a. providing an auxiliary shelving system comprising:
a first support wall and a second support wall, each support wall having a plurality of spaced apart feet, the support walls being perpendicularly joined together to form an L-shaped configuration; and
a plurality of auxiliary shelves;
b. positioning the first support wall adjacent the rear wall and the second support wall adjacent the side wall, and with the feet resting on the standard refrigerator shelf; and
c. removably securing an edge of each auxiliary shelf to a portion of either the first support wall or the second support wall so that the auxiliary shelf extends into the storage space of the storage compartment.

8. The method of claim 7, further including:
providing a plurality of holes in the first and second support walls;
providing each auxiliary shelf with a plurality of ears along at least one edge of the auxiliary shelf; and
providing a plurality of connection pins;
extending each pin through an ear into a corresponding hole in either of the support walls, so to connect an auxiliary shelf to a support wall.

9. The method of claim 7, further including providing a suction cup at the bottom of each of the feet.

10. The method of claim 7, further including providing the plurality of auxiliary shelves in different shapes and sizes.

11. The method of claim 7, further including providing each auxiliary shelf with at least one brace.

12. The method of claim 7, further including:
positioning two auxiliary shelves are side-by-side to each other, and using a pin to connect the ears on the adjacent edges of the two auxiliary shelves.
